(19) United States
(12) Patent Application Publication
(10) Pub. No.: US 2025/0025967 A1
(43) Pub. Date: Jan. 23, 2025

(54) DEVICE FOR CONTROLLING QUALITY OF WIRE ARC ADDITIVE FORMING THROUGH FEEDBACK OF ACOUSTIC EMISSION

(71) Applicant: North University of China, Taiyuan City (CN)

(72) Inventors: Bin LIU, Taiyuan City (CN); Wei CHEN, Taiyuan City (CN); Zhen ZHANG, Taiyuan City (CN); Zhonghua LI, Taiyuan City (CN); Peikang BAI, Taiyuan City (CN)

(73) Assignee: North University of China, Taiyuan City (CN)

(21) Appl. No.: 18/598,802

(22) Filed: Mar. 7, 2024

(30) Foreign Application Priority Data
Jul. 19, 2023 (CN) 202310886814.9

(51) Int. Cl. B23K 31/12; B23K 9/04; B33Y 30/00; G01N 29/04; G01N 29/14

(52) U.S. Cl. CPC B23K 31/125; B23K 9/04; B33Y 30/00; G01N 29/043; G01N 29/14; G01N 2291/0289

(57) ABSTRACT

A device for controlling quality of wire arc additive forming through feedback of acoustic emission comprises a wire arc additive system, an acoustic emission acquisition and identification system, and a feedback control system. The wire arc additive system is configured for forming solid parts by a wire arc additive process. The acoustic emission acquisition and identification system is configured for monitoring the wire arc additive process online and analyzing types and sizes of any resulting defects. The feedback control system is configured for analyzing monitored results and providing timely feedback to the wire arc additive system via a PID circuit. When the resulting defects are small, the types and sizes of defects are analyzed, and an instruction of correcting process parameters is sent to the wire arc additive system. When the resulting defects are too large to be remedied, a shutdown instruction is sent to the wire arc additive system.

### RELATED APPLICATION

This patent application claims the benefit and priority of Chinese Patent Application No. 202310886814.9 filed with the China National Intellectual Property Administration on Jul. 19, 2023, the disclosure of which is incorporated by reference herein in its entirety for all purposes.

### FIELD OF THE INVENTION

The present disclosure belongs to the technical field of additive manufacturing, and specifically relates to devices for controlling the quality of wire arc additive manufacture.

### BACKGROUND OF THE INVENTION

At present, wire arc additive manufacturing is considered to be the technology having the highest forming speed in metal additive manufacturing, and has great advantages in forming large-scale parts. However, due to its large heat input and obvious accumulation of the heat input with the progress of machining, an unchanged forming process easily leads to cracks, holes, and other defects in the formed parts, thus seriously affecting the service life of the parts. Therefore, the forming process is monitored with on-line monitoring methods, and a feedback control is performed on the forming process through real-time feedback of monitoring results, so that the quality of the formed parts can be effectively improved.

Common on-line monitoring methods mainly include visual monitoring, ultrasonic monitoring, ray monitoring, thermal imaging monitoring, acoustic emission monitoring and so on. Visual monitoring is limited by pixels of a camera, and has low sensitivity to small defects. It is difficult for ultrasonic monitoring and ray monitoring to penetrate thick metal parts. Thermal imaging monitoring has high requirements on the ability of computer data processing and it is difficult to provide real-time feedback. Acoustic emission monitoring has the advantages of high sensitivity, quick response, and low cost, and it is very suitable for popularization and use. Acoustic emission refers to the phenomenon that when a material is deformed or broken under an external or internal force, stress concentration is occurred in local areas of the material, energy is released rapidly, and transient elastic waves are produced. If it is intended to acquire the clearest and most complete acoustic emission signals through an acoustic emission sensor, the acoustic emission sensor is required to be tightly attached to a surface of the material to be measured.

At present, acoustic emission technology in the field of wire arc additive manufacturing and even the whole additive manufacturing is merely used for monitoring the forming process, identifying types and sizes of defects in the additive process. However, substantial quality remedy for the defective parts or relevant improvement on the additive manufacturing system is not carried out.

### SUMMARY OF THE INVENTION

The purpose of the present disclosure is to solve the above problems existing in the prior art, and provides a device for controlling quality of wire arc additive forming through feedback of acoustic emission.

The present disclosure is achieved through the following technical solutions.

A device for controlling quality of wire arc additive forming through feedback of acoustic emission includes three subsystems: a wire arc additive system, an acoustic emission acquisition and identification system, and a feedback control system, and the three subsystems are connected in a closed loop. The wire arc additive system is configured for forming solid parts. The acoustic emission acquisition and identification system is configured for monitoring a wire arc additive process on line and analyzing types and sizes of the resulting defects. The feedback control system is configured for analyzing monitoring results and providing timely feedback to the wire arc additive system by a PID (Proportional-Integral-Differential) circuit. When the resulting defects are small, the types and sizes of defects are analyzed, an instruction of correcting process parameters is sent to the wire arc additive system, and remedial measures are taken to the parts to obtain high-quality parts. When the resulting defects are too large to be remedied by adjusting parameters, a shutdown instruction is sent to the wire arc additive system, and an alarm is raised to wait for manual processing and prevent material loss of waste parts in time.

The wire arc additive system includes a wire arc forming worktable, a robotic arm, an argon arc welding gun, a mainframe box, a teach pendant, a wire feeder, a welding machine, shielding gas, and a water tank. The robotic arm is arranged on one side of the wire arc forming worktable. The argon arc welding gun is connected to an end of the robotic arm. The teach pendant is connected with the mainframe box in a coordinated manner. The wire feeder is connected with the welding machine in a coordinated manner. The shielding gas, the water tank, and the welding machine are connected with the mainframe box, respectively. The mainframe box is connected with the robotic arm. The teach pendant, the wire feeder, the welding machine, the shielding gas, and the water tank are coordinated with the robotic arm and the argon arc welding gun through a control system of the mainframe box.

The acoustic emission acquisition and identification system includes an acoustic emission sensor, a preamplifier, an acoustic emission signal acquisition device, and a computer. The acoustic emission sensor is connected to the wire arc forming worktable to acquire AE (Acoustic Emission) signals in a working area of the wire arc additive system. The acoustic emission sensor is connected with the preamplifier. The preamplifier is connected with the acoustic emission signal acquisition device. The acoustic emission signal acquisition device is connected with the computer.

The feedback control system includes a PID (Proportional-Integral-Differential) circuit. The PID circuit is configured for receiving the monitoring results of the acoustic emission acquisition and identification system. The PID circuit includes three adjustment elements: proportional element (P), integral element (I) and differential element (D). According to different processes of the PID circuit, corresponding feedback instructions are sent to the wire arc additive system. The feedback instructions are divided into three types: maintaining printing parameters, changing printing parameters, as well as shutting down and raising an alarm.

Further, in the feedback control system, an adjustment by the proportional element is used to reflect deviation of the system in proportion; and once the deviation is occurred in the system, the adjustment by the proportional element works immediately to reduce the deviation.

Further, in the feedback control system, an adjustment by the integral element is to eliminate steady-state errors in the system and increase indiscrimination degree. As long as there are errors, the adjustment by the integral element is carried out. When the adjustment by the integral element is stopped, a constant value is output through the adjustment by the integral element.

Further, in the feedback control system, an adjustment by the differential element is to reflect a change rate of a deviation signal of the system through differential action. The adjustment by the differential element is predictive and capable of predict a change trend of deviation, an advanced control effect can be achieved. Before the deviation is formed, the deviation has been eliminated through the adjustment by the differential element.

Further, if the quality of a formed part is high, the corresponding feedback instruction is maintaining printing parameters. If small defects are arisen in the formed part, the corresponding feedback instruction is changing printing parameters. If large defects are arisen in the formed part, the corresponding feedback instruction is shutting down and raising an alarm.

The working principle of the device in the present disclosure is as follows.

A three-dimensional part image is designed on the computer, sliced by the relevant software and introduced into the wire arc additive system, and the wire arc additive system starts the operation of forming parts. In the process of the wire arc additive forming of the parts, AE signals are acquired by the acoustic emission sensor in the wire arc additive working area (wire arc forming worktable). The AE signals are amplified by the preamplifier, then enter the acoustic emission signal acquisition device for noise removal and feature parameters extraction, and finally are transmitted back to the computer. The computer models the feature parameters and identifies the types and sizes of the defects, and inputs the identification results into the feedback control system. Corresponding feedback instructions are sent by the feedback control system to the wire arc additive system through different adjustment elements of the PID circuit according to the types and sizes of the defects. Three types of feedback instructions are sent according to the types and sizes of the defects: maintaining printing parameters, changing printing parameters (output power, scanning speed, magnitude of the shielding gas, wire feeding speed, temperature of the water tank, and the like), as well as shutting down and raising an alarm. Specifically, if the AE signals indicate that the formed parts are free of defects, the printing parameters are maintained, and printing is continued. If the AE signals indicate that small defects are arisen in the formed parts, the feedback instruction of changing printing parameters is sent, and the printing is continued after the printing parameters have been changed. If the AE signals indicate that large defects are arisen in the formed parts, the feedback instruction of shutting down and raising an alarm is sent to wait for manual processing.

The device in the present disclosure has the advantages of scientific design, reasonable structure, simple operation and convenient use. Defects in the wire arc additive process are acquired and identified through acoustic emission technology, and the causes of defects in different degrees are analyzed through the feedback control system. For the parts with small defects, the printing parameters are adjusted, so that the quality of the formed parts is improved. For the parts with large defects, shutdown processing is carried out, so that materials for waste parts are saved.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The following drawings, as a part of the present disclosure, are provided for further description of the present disclosure. Exemplary embodiments and description thereof in the present disclosure are used for explaining the principle of the present disclosure, and do not intend to limit the present disclosure.

FIG. 1 is a process flow diagram of a device according to an embodiment of the present disclosure;

FIG. 2 is a structural schematic diagram of a wire arc additive system in a device according to an embodiment of the present disclosure;

FIG. 3 is a structural schematic diagram of an acoustic emission acquisition and identification system in a device according to an embodiment of the present disclosure;

FIG. 4 is a PID circuit diagram of a feedback control system in a device according to an embodiment of the present disclosure;

FIG. 5 is a control schematic diagram of a feedback control system in a device according to an embodiment of the present disclosure;

FIG. 6 is an appearance schematic diagram of a part formed by a conventional device in prior art; and

FIG. 7 is an appearance schematic diagram of a part formed by a device according to an embodiment of the present disclosure.

### DETAILED DESCRIPTION

In order to enable those skilled in the art to better understand the present disclosure, the following further clearly and completely illustrates the present disclosure with reference to the attached drawings and embodiments. It needs to be illustrated that, the embodiments in the present disclosure and the features in the embodiments can be combined with each other without conflict.

In the description of the embodiments, it needs to be illustrated that, unless otherwise expressly specified and limited, the terms such as “connection” should be understood in a broad sense, for example, the “connection” may be a fixed connection, a detachable connection or an integral connection, it may be a mechanical connection, or an electrical connection, it may be a direct connection, or an indirect connection through an intermediate medium, and it may be an internal communication between two elements. For those skilled in the art, the specific meanings of the above terms in the present disclosure can be understood according to specific conditions.

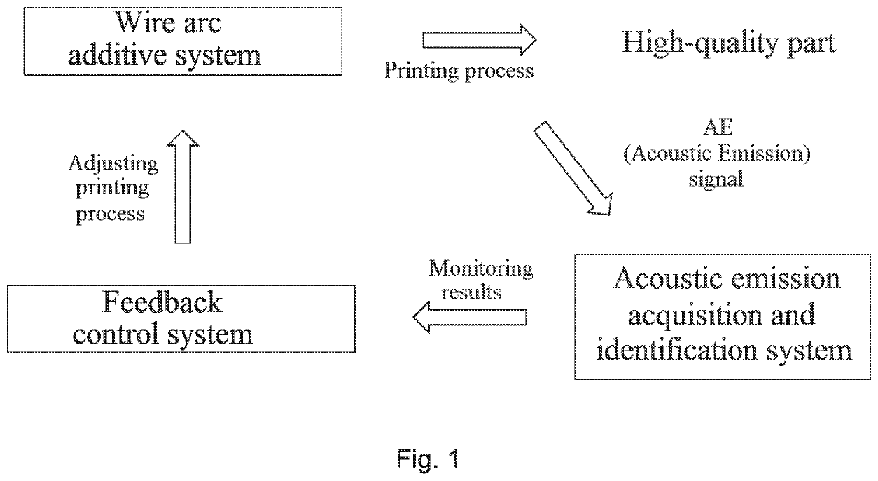

A device for controlling quality of wire arc additive forming through feedback of acoustic emission includes three subsystems: a wire arc additive system, an acoustic emission acquisition and identification system, and a feedback control system, and the three subsystems are connected in a closed loop. The process flow of the three subsystems is shown in FIG. 1. The acoustic emission acquisition and identification system monitors the printing process of the wire arc additive system, and then inputs monitoring results into the feedback control system. The feedback control system adjusts printing parameters in real time through the monitoring results. The three systems work together to print high-quality parts.

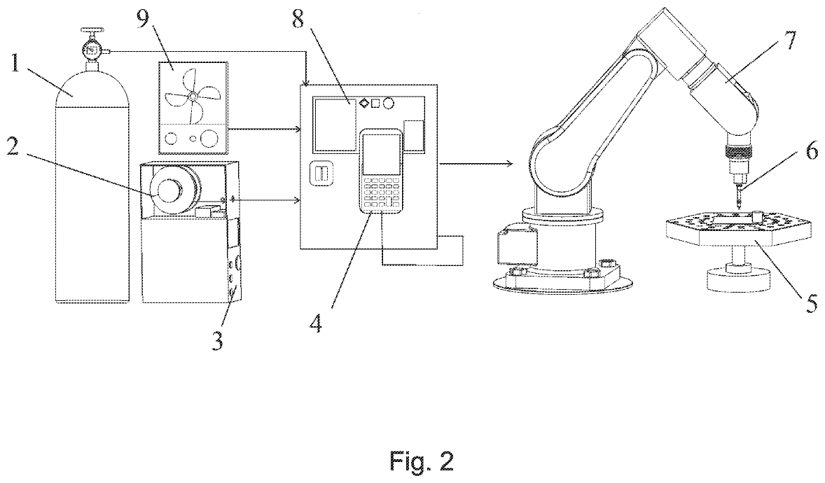

As shown in FIG. 2, the wire arc additive system includes a wire arc forming worktable 5, a robotic arm 7, an argon arc welding gun 6, a mainframe box 8, a teach pendant 4, a wire feeder 2, a welding machine 3, shielding gas 1, and a water tank 9. The wire arc forming worktable 5 is configured for forming formed parts 14. The robotic arm 7 is arranged on one side of the wire arc forming worktable 5. The argon arc welding gun is connected to an end of the robotic arm 7. The teach pendant 4 is connected with the mainframe box 8 in a coordinated manner. The wire feeder 2 is connected with the welding machine 3 in a coordinated manner. The shielding gas 1, the water tank 9, and the welding machine 3 are connected with the mainframe box 8, respectively. The mainframe box 8 is connected with the robotic arm 7. The teach pendant 4, the wire feeder 2, the welding machine 3, the shielding gas 1, and the water tank 9 are coordinated with the robotic arm 7 and the argon arc welding gun through a control system of the mainframe box 8. The teach pendant 4 is coordinated with the mainframe box 8 to control a moving path of the robotic arm 7. The wire feeder 2 is coordinated with the welding machine 3 to control arc ignition and arc extinguishing of the argon arc welding gun 6. The shielding gas 1 prevents the occurrence of excessive oxidation in the wire arc process. Water in the water tank 9 circulates through all components to prevent temperature of the wire arc additive system from being too high.

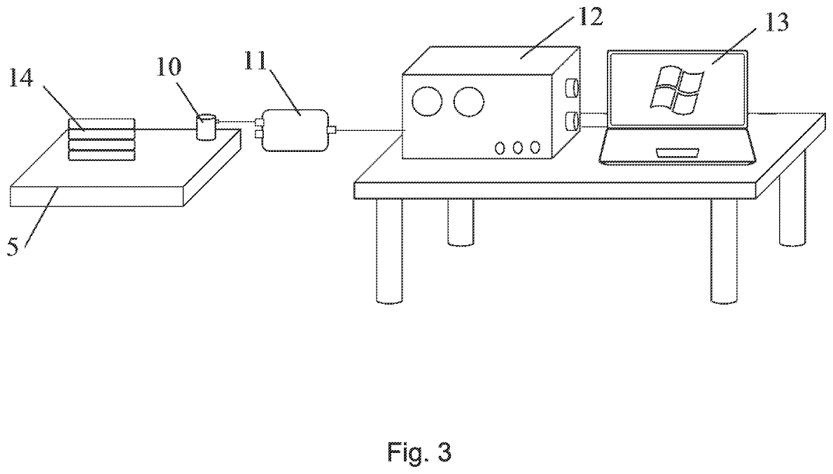

As shown in FIG. 3, the acoustic emission acquisition and identification system includes an acoustic emission sensor 10, a preamplifier 11, an acoustic emission signal acquisition device 12, and a computer 13. The acoustic emission sensor 10 is connected to the wire arc forming worktable 5 to acquire AE signals in a working area of the wire arc additive system. The acoustic emission sensor 10 is connected with the preamplifier 11. The preamplifier 11 is connected with the acoustic emission signal acquisition device 12. The acoustic emission signal acquisition device 12 is connected with the computer 13. The acoustic emission sensor 10 acquires the AE signals in the working area of the wire arc additive system. The preamplifier 11 amplifies weak signals. The acoustic emission signal acquisition device 12 removes noise and extracts feature parameters. Relevant software equipped in the computer 13 is configured for analyzing types and sizes of defects arisen in the forming process.

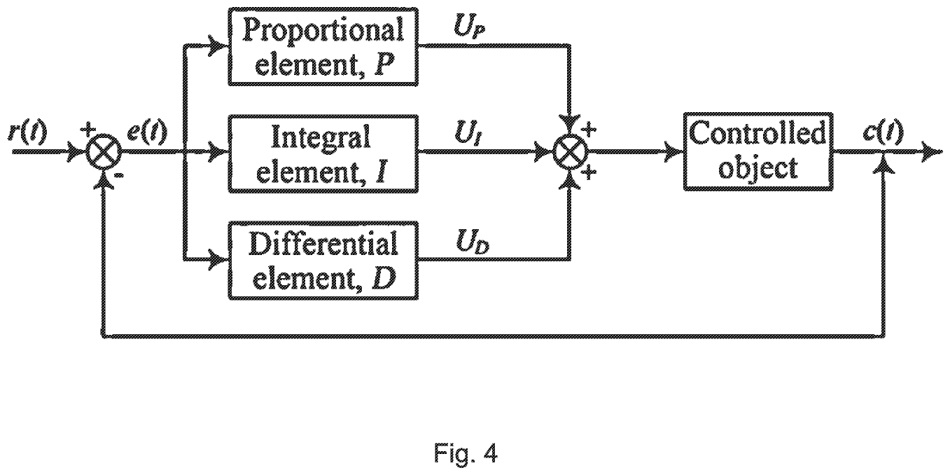

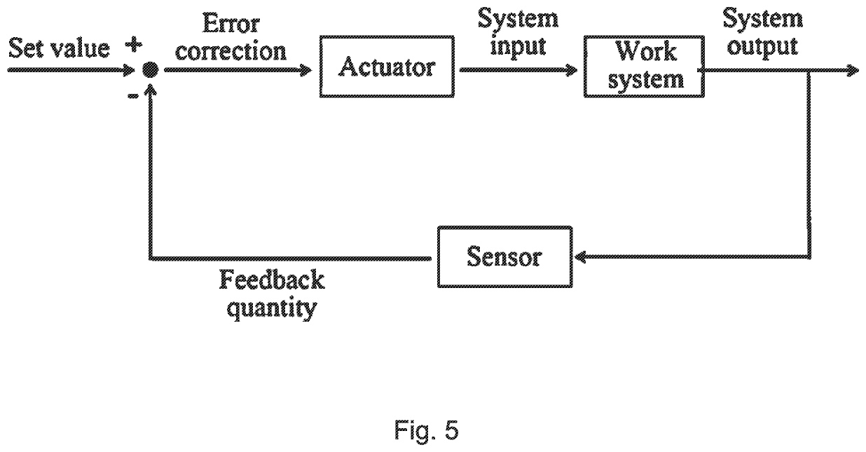

As shown in FIG. 4, the feedback control system includes a PID circuit. The PID circuit is configured for receiving the monitoring results of the acoustic emission acquisition and identification system. The PID circuit includes three adjustment elements: proportional element P, integral element I, and differential element D. Adjustment by the proportional element is to reflect deviation of the system in proportion. Once the deviation is occurred in the system, the adjustment by the proportional element works immediately to reduce the deviation. Adjustment by the integral element is to eliminate the steady-state errors in the system and increase indiscrimination degree. As long as there are errors, the adjustment by the integral element is carried out. When the adjustment in integral element is stopped, a constant value is output through the adjustment by the integral element. Adjustment by the differential element is to reflect a change rate of a deviation signal of the system through differential action. Since the adjustment by the differential element is predictive and can predict a trend of deviation change, an advanced control effect can be achieved. Before the deviation is formed, the deviation has been eliminated through the adjustment by the differential element. As shown in FIG. 5, the principle of the feedback control system is as follows. An instruction is sent by the system. The instruction is read by an actuator and a working system and starts to operate. The sensor is used for monitoring the working process. Once any abnormalities are occurred in the process, the instruction sent by the system is properly corrected at once, so that the working process is returned to normal. That is, according to different processes of the PID circuit, corresponding feedback instructions are sent. The feedback instructions are divided into three types: maintaining printing parameters, changing printing parameters, as well as shutting down and raising an alarm. If the quality of formed parts 14 is high, the corresponding feedback instruction is maintaining printing parameters. If small defects are arisen in the formed parts 14, the corresponding feedback instruction is changing printing parameters. If large defects are arisen in the formed parts 14, the corresponding feedback instruction is shutting down and raising an alarm.

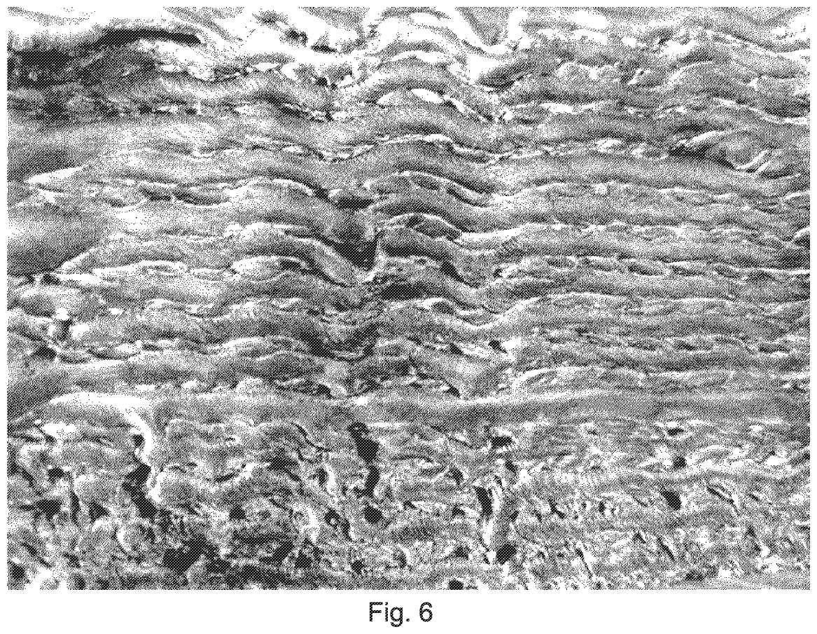

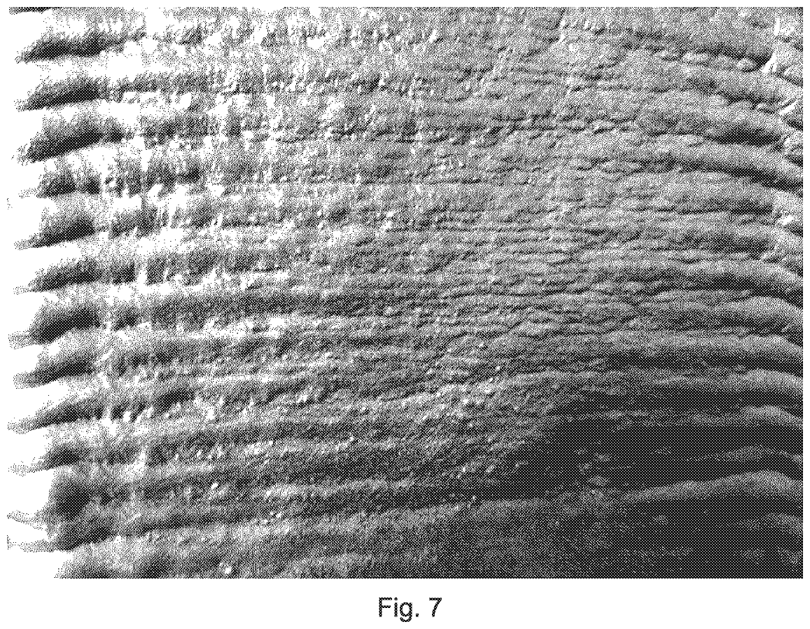

FIG. 6 is an appearance schematic diagram of a part formed by a conventional device in prior art. From this figure, it can be concluded that weld beads of the part are uneven, the bonding of the weld layer is not dense, and the surface and the interior of the part are full of defects such as holes and cracks. FIG. 7 is an appearance schematic diagram of a part formed by the device in the present disclosure. From this figure, it can be seen that weld beads of the part are even, the bonding of the weld layer is dense, and the surface is smooth and flat.

The technical contents of the present disclosure are further described in conjunction with several specific embodiments.

### Embodiment I

A method for preparing a part through a device for controlling quality of wire arc additive forming through feedback of acoustic emission in the present disclosure includes the following steps:
Step 1, a three-dimensional part image is designed by software in a computer 13, the three-dimensional part image is sliced and processed by relevant software, the sliced and processed image is introduced into a wire arc additive system, and the wire arc additive system starts the preparation of a formed part 14.
Step 2, the forming process of the formed part 14 is monitored by an acoustic emission acquisition and identification system, AE signals are acquired by an acoustic emission sensor 10, amplified by a preamplifier 11, enter the acoustic emission acquisition and identification system for noise removal and feature parameters extraction, and then enter the computer 13 for identification.
Step 3, if the computer 13 prompts the occurrence of splashing in the forming process of the part 14, monitoring results are inputted into a feedback control system.
Step 4, the splashing process is analyzed through the feedback control system, and the cause of splashing is found that: the magnitude of shielding gas 1 is insufficient.
Step 5, an instruction of increasing the magnitude of shielding gas 1 is sent by the feedback control system to the wire arc additive system through a PID circuit.
Step 6, a coordinate control is carried out through a mainframe box 8 in the wire arc additive system to increase the output pressure of the shielding gas 1.
Step 7, the splashing process and the instruction of increasing the magnitude of the shielding gas 1 are recorded into the computer 13.
Step 8, the forming process of the part is returned to normal, and the forming quality of the formed part 14 is improved.

### Embodiment II

A method for preparing a part through a device for controlling quality of wire arc additive forming through feedback of acoustic emission in the present disclosure includes the following steps:
Step 1, a three-dimensional part image is designed by software in a computer 13, the three-dimensional part image is sliced and processed by relevant software, the sliced and processed image is introduced into a wire arc additive system, and the wire arc additive system starts the preparation of a formed part 14.
Step 2, the forming process of the part is monitored by an acoustic emission acquisition and identification system, AE signals are acquired by an acoustic emission sensor 10, amplified by a preamplifier 11, enter the acoustic emission acquisition and identification system for noise removal and feature parameters extraction, and then enter the computer 13 for identification.
Step 3, if the computer 13 prompts there are holes in the formed part 14, monitoring results are inputted into a feedback control system.
Step 4, the process of forming the holes is analyzed through the feedback control system, and the cause of forming the holes is found that: the output of current is too small to fully melt the metal welding wires.
Step 5, an instruction of increasing the welding current is sent by the feedback control system to the wire arc additive system through a PID circuit.
Step 6, a coordinate control is carried out through a mainframe box 8 in the wire arc additive system to increase the current of arc. By means of the increased current of the arc, the upper partially melted layer with holes is further melted, so that the layers are combined densely.
Step 7, the process of forming the holes and the instruction of increasing the current of the arc are recorded into the computer 13.
Step 8, the forming process of the part is returned to normal, and the forming quality of the formed part 14 is improved.

### Embodiment III

A method for preparing a part through a device for controlling quality of wire arc additive forming through feedback of acoustic emission in the present disclosure includes the following steps:
Step 1, a three-dimensional part image is designed by software in a computer 13, the three-dimensional part image is sliced and processed by relevant software, the sliced and processed image is introduced into a wire arc additive system, and the wire arc additive system starts the preparation of a formed part 14.
Step 2, the forming process of the part is monitored by an acoustic emission acquisition and identification system, AE signals are acquired by an acoustic emission sensor 10, amplified by a preamplifier 11, enter the acoustic emission acquisition and identification system for noise removal and feature parameters extraction, and then enter the computer 13 for identification.
Step 3, if the computer 13 prompts there are huge holes and cracks in the formed part 14, monitoring results are inputted into a feedback control system.
Step 4, the holes and cracks, and other defects are analyzed through the feedback control system, and it is found that the defects cannot be completely eliminated.
Step 5, an instruction of shutting down is sent by the feedback control system to the wire arc additive system through a PID circuit.
Step 6, the operation of the wire arc additive system is stopped.
Step 7, the operation of the acoustic emission acquisition and identification system is stopped.
Step 8, the forming process of the holes and cracks, as well as the instruction of shutting down are displayed in the computer 13, and an alarm is raised by the feedback control system to wait for manual processing.

### REFERENCE SIGNS

1 shielding gas;
2 wire feeder;
3 welding machine;
4 teach pendant;
5 wire arc forming worktable;
6 argon arc welding gun;
7 robotic arm;
8 mainframe box;
9 water tank;
10 acoustic emission sensor;
11 preamplifier;
12 acoustic emission signal acquisition device;
13 computer; and
14 formed part.

The above clearly and completely describes the technical solutions in embodiments of the present disclosure. The described embodiments are merely a part, rather than all, of the embodiments of the present disclosure. Based on the embodiments of the present disclosure, all other embodiments obtained by those skilled in the art without creative efforts shall fall within the protection scope of the present disclosure.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A device for controlling quality of wire arc additive forming through feedback of acoustic emission, the device comprising:
three systems connected in a closed loop, the three systems being a wire arc additive system configured for forming solid parts, an acoustic emission acquisition and identification system configured for monitoring a wire arc additive process on line and analyzing types and sizes of the resulting defects, and a feedback control system 6 configured, according to said monitoring and analyzing, for providing timely feedback to the wire arc additive system by a PID (Proportional-Integral-Differential) circuit;
wherein the wire arc additive system comprises:
a wire arc forming worktable;
a robotic arm arranged on one side of the wire arc forming worktable;
an argon arc welding gun connected to an end of the robotic arm;
a mainframe box connected with the robotic arm;
a teach pendant connected with the mainframe box in a coordinated manner;
a welding machine connected with the mainframe box;
a wire feeder connected with the welding machine in a coordinated manner;
a shielding gas connected with the welding machine in a coordinated manner; and
a water tank connected with the mainframe box;
wherein the acoustic emission acquisition and identification system comprises:
a computer;
an acoustic emission sensor, the acoustic emission sensor being connected to the wire arc forming worktable and being connected with the preamplifier;
an acoustic emission signal acquisition device connected with the computer; and
a preamplifier connected with the acoustic emission signal acquisition device;
and wherein the feedback control system comprises a PID (Proportional-Integral-Differential) circuit, said PID circuit comprising a proportional adjustment element P, an integral adjustment element I, and a differential adjustment element D;
said feedback control system being configured, according to different processes of the PID circuit, to send corresponding feedback instructions to the wire arc additive system, each of said feedback instructions being either an instruction to maintain the printing parameters, an instruction to change the printing parameters, or an instruction to cease wire arc additive forming and raise an alarm.

2. The device for controlling quality of wire arc additive forming through feedback of acoustic emission according to claim 1, wherein the feedback control system is configured, when there is a deviation of the feedback control system, to adjust said proportional adjustment element in proportion to the deviation of the feedback control system so as to reduce the deviation of the feedback control system.

3. The device for controlling quality of wire arc additive forming through feedback of acoustic emission according to claim 1, wherein the feedback control system is configured to adjust the integral adjustment element so as to eliminate steady-state errors in the feedback control system and to increase a degree of indiscrimination, said adjustments of the integral adjustment element continuing until said steady-state errors in the feedback control system are eliminated, after which a constant value is output by the integral adjustment element.

4. The device for controlling quality of wire arc additive forming through feedback of acoustic emission according to claim 1, wherein the feedback control system is configured, according to a change rate of a deviation signal of the feedback control system, to differentially adjust the differential adjustment element, said adjustment of the differential adjustment element being according to a prediction of a change trend of the deviation signal of the feedback control system, thereby achieving a predictive control effect whereby said change trend of the deviation signal of the feedback control system is substantially eliminated by the adjustment of the differential adjustment element.

5. The device for controlling quality of wire arc additive forming through feedback of acoustic emission according to claim 1, wherein the feedback control system is configured to send the feedback instructions according to a quality of a formed part, wherein, for each of said feedback instructions:
when the quality of the formed part is high, the feedback instruction will be the instruction to maintain the printing parameters;
when the formed part includes at least one small defects, the feedback instruction will be the instruction to change the printing parameters; and
if the formed part includes at least one large defect, the feedback instruction will be the instruction to cease wire arc additive forming and raise an alarm.
